(19) United States
(12) Patent Application Publication
(10) Pub. No.: US 2026/0350929 A1
(43) Pub. Date: Nov. 5, 2026

(54) INTERACTIVE MIXED REALITY (MR) BASED NETWORK MEASUREMENT AND TESTING

(71) Applicant: VIAVI SOLUTIONS INC., Chandler, AZ (US)

(72) Inventors: Niki KIRSCHENMANN, Unterhausen (DE); Raleigh Benton STELLE, IV, Indianapolis, IN (US)

(73) Assignee: VIAVI SOLUTIONS INC., Chandler, AZ (US)

(21) Appl. No.: 19/194,634

(22) Filed: Apr. 30, 2025

(51) Int. Cl. G06T 19/00

(52) U.S. Cl. CPC G06T 19/006

(57) ABSTRACT

A Mixed Reality (MR) based network test application generates an MR overlay display on a panel of network nodes, with the subset of network nodes to be tested being identified by selectable controls. To test a network node, a corresponding one of the selectable controls is clicked to retrieve the test list, including tests to be conducted on the network node to be tested. The MR overlay display is updated as the network nodes are tested and the test results are recorded for further analysis.

### BACKGROUND

Augmented reality (AR) enhances real-world experiences by overlaying computer-generated, digital information onto a user's view of the real world, creating an interactive experience. Virtual Reality(VR) creates a virtual, computer-generated environment. Mixed Reality (MR) is a technology that combines elements of both AR and VR, allowing users to interact with real and virtual objects in the same environment. MR uses software, apps, and sometimes specialized hardware (like AR glasses) to overlay digital content, such as images, videos, or text, onto a user's view of their real-world surroundings. MR technology typically involves a camera on a device (like a smartphone or tablet) capturing the real-world view, and then processing that view and overlaying digital elements. While MR systems find applications in manufacturing, logistics, healthcare, and other industries, technical challenges that hinder the smooth functioning of MR systems include poor connectivity, expensive hardware, and limited battery life of devices.

### BRIEF DESCRIPTION OF THE DRAWINGS

Features of the present disclosure are illustrated by way of examples shown in the following figures. In the following figures, like numerals indicate like elements, in which:

FIG. 1A shows a block diagram of a portable network testing device executing an MR-based network test application according to an example of the present disclosure;

FIG. 1B shows a block diagram of a workflow provider according to an example of the present disclosure;

FIG. 1C shows a block diagram of a component identifier according to an example of the present disclosure;

FIG. 2 shows a flowchart of a method of testing a network device in accordance with an example;

FIG. 3 shows a flowchart of a method of executing tests on a selected network node in accordance with examples disclosed herein;

FIG. 4 shows the various tools, including User Interfaces (ideUIs), employed in the process of creating tests for network devices in accordance with examples disclosed herein;

FIG. 5 shows the various configuration UIs for the MR-based network test application in accordance with the disclosed examples; and

FIG. 6 shows the MR-based UIs that are generated when testing the network nodes in accordance with the disclosed examples.

### DETAILED DESCRIPTION

For simplicity and illustrative purposes, the present disclosure is described by referring mainly to examples thereof. In the following description, details are set forth in order to provide an understanding of the present disclosure. It will be readily apparent, however, that the present disclosure may be practiced without limitation to these details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but is not limited to, and the term “including” means including but not limited to. The term “based on” means based at least in part on.

Disclosed herein are examples of MR systems for network testing that mitigate the aforementioned technical difficulties when used for industrial applications. In particular, a portable network testing system is disclosed which generates an MR overlay display on a network device to be tested, executes the tests, and enables generation of a test report. The MR-based network test application can be configured to not only test communication equipment in commercial establishments such as large data centers, but can also be used to test communication ports used for domestic purposes, such as equipment used in small apartment complexes. Furthermore, the MR-based network test application leads a technician from the initial step of locating the network device to be tested to producing the test results and enabling addressing problems that may occur in a tested network device. Test results from the MR-based network test application can also be used to determine the performance of the technician administering the tests.

The MR-based network test application, in accordance with an aspect, does not require specialized hardware for execution. Common user devices such as smartphones or tablets can be used by the technician for testing network devices. The MR-based network test application can be downloaded and installed on the user device, and the hardware therein, such as a camera, can be employed for executing the tests. The networks tested can include not only fiber-based networks, but may also include copper-based network topology, e.g., twisted pair/Digital Subscriber Line (DSL), Ethernet distributions, wireless networks for cellular and Wireless Fidelity (Wi-Fi) deployments, and hybrid networks such as fiber networks to remote last leg devices. Various tests, such as but not limited to, optical return loss, fiber length, fiber inspection, optical power level which is a power level at the measuring point, optical loss, optical return loss, fiber length, polarity, inspection, Passive Optical Network Port Identification (PONID), Optical Distribution Network Class Identification and Transmitted Optical Power Level Identification which is the power level directly from the transmitter and throughput tests, can be run on the user device. In an example, additional equipment may not be required for executing the tests so that the required measurements can be made with the MR-based overlay. However, certain tests may require that additional equipment be connected to the network device or a network node being tested, and the readings entered in the MR-based network test application.

In order to enable a test session, a workflow for the test session is generated by a workflow model. The workflow model can access information regarding the network devices and network nodes to be tested to generate a workflow optimized for efficiency for the particular test session. The optimized workflow not only includes a sequence of test steps to be executed by a technician but also the time taken for execution of the steps, which factors in the time of travel of the technician from one network device to another. In an example, the workflow model can be hosted on a test server, and the estimations from the workflow model can be further refined by real-time inputs such as the time of travel mentioned above, from the MR-based network test application. The resulting workflow interaction not only provides guidance and training to the technician but enables monitoring and collecting test data, which can be used to provide an evaluation of the testing process on completion of the tests based on a comparison of the time estimated from the optimized workflow versus actual time taken to complete the tests. Furthermore, the data collected during the test can be used as feedback to further train the workflow model for improved accuracy.

When the MR-based network test application is initially activated on the user device, a map with directions to a location of one or more network devices to be tested can be initially generated. The map can be generated from the location of the user device or a reference location based on internet connectivity. In an example, the map generation step can be skipped by the technician to begin testing of a network node. The MR-based network test application initially generates an MR overlay display identifying a subset of network nodes to be tested using a label list, which includes a listing of the network nodes or identification data of components of the network device to be tested in a predetermined format or schema. The generated overlay display will depend on the type of network node being tested. For example, the overlay display for a fiber network node may be different as compared to the overlay display for a copper-based network topology. Hence, while some examples may be discussed herein with respect to a particular network type, similar aspects can also be applied to other network types. The subset of network nodes is identified by selectable controls such as virtual buttons overlaid on the network nodes. When the technician clicks on a button, the test list, including tests to be executed on the particular network node, is loaded. The tests are executed and the results are recorded to the local storage and uploaded to a test server, which may be remote from the portable network testing device.

The panels of network devices to be tested are complicated, with hundreds of cables and wires emerging from the various connections on the panel. Identifying a particular node or wire to be tested can be an extremely tedious task, thereby slowing down the testing procedure. As mentioned above, the label list includes components to be tested in predetermined formats, which may be decoded by a technician to identify the network node(s) to be tested. Oftentimes, inexperienced technicians may fail to accurately identify the network nodes to be tested, leading them to test the wrong components. By enabling network node identification via the MR overlay display, the MR-based network test application disclosed herein mitigates the need for the technicians to identify the network nodes to be tested and, therefore, improves the accuracy and efficiency of network testing applications. The MR-based network test application disclosed herein therefore enables accurate and faster identification of network components, thereby correspondingly improving the accuracy and efficiency of network test applications.

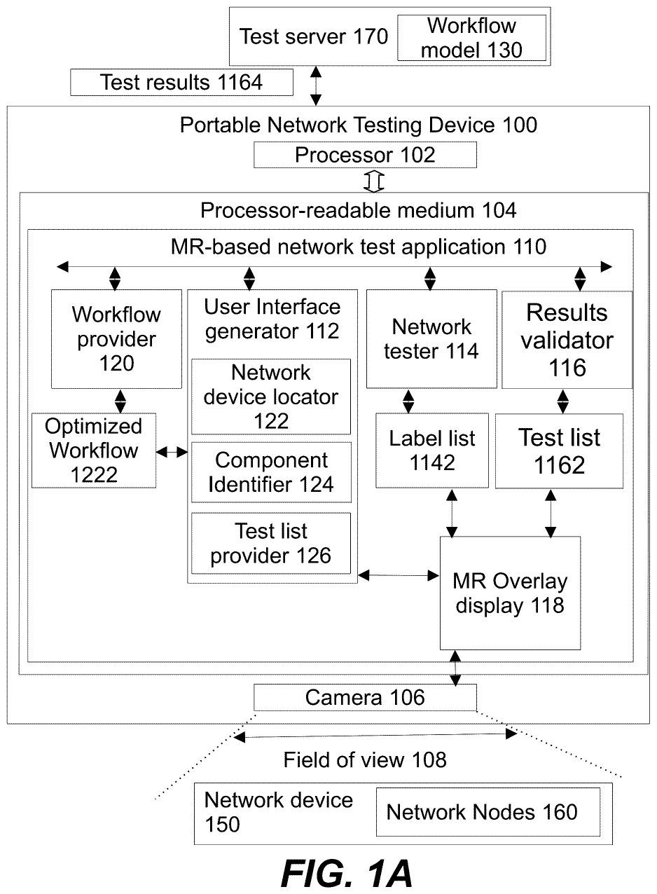

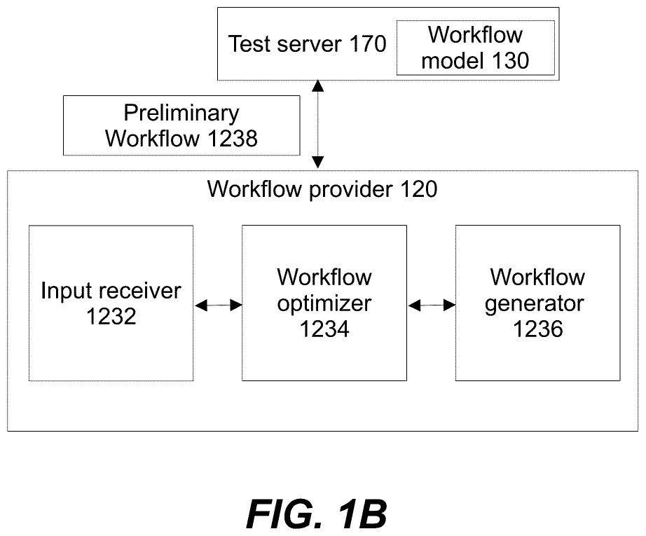

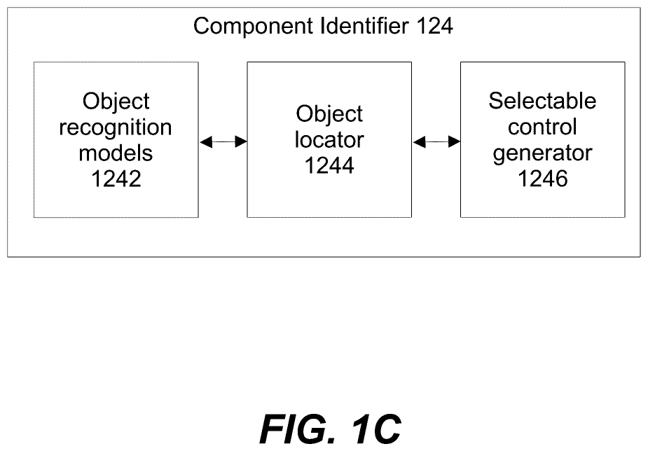

FIG. 1A shows a block diagram of a portable network testing device 100 according to an example of the present disclosure. The portable network testing device 100 can include a handheld device such as a smartphone or a proprietary portable device that has an MR-based network test application 110 stored in an on-board memory such as a processor-readable medium 104 as programming instructions executable by a processor 102 of the portable network testing device 100. The portable network testing device 100 may be communicatively coupled to a test server 170 and used for testing a network device 150, including network nodes 160 to be tested either through physical connections with cables or without physical contact with the network device 150. Even if physically connected, the network nodes 160 may be focused within the field of view 108 of a camera 106 of the portable network testing device 100 for indicating the network nodes to be tested to a technician. The programming instructions constitute a user interface generator 112, a network tester 114, a results validator 116, and a workflow provider 120. The workflow provider 120 generates a workflow 1222 that is optimized for efficiency. In an example, a workflow model 130 hosted on the test server 170 can be trained to generate the optimized workflow 1222 for a test session. The user interface generator 112 generates and displays the appropriate UIs depending on the particular stage of testing in the test sequence, as given in the workflow 1222. The network tester 114 provides information regarding one or more of the network nodes 160 to be tested and the tests to be executed on the one or more network nodes. The results validator 116 indicates if a test is completed and allows the process to proceed further. The test results 1164 are stored to the non-transitory processor-readable medium 104 and where there is network connectivity, the results validator 116 may upload the test results to a test server 170; otherwise, the results validator 116 may conduct limited analysis of the test results locally and later upload the test results upon gaining connection to the internet.

The user interface generator 112 includes a network device locator 122, a component identifier 124, and a test list provider 126. The network device locator 122 generates a map of a route to the network device 150. As mentioned herein, the portable network testing device 100 may be used to test network devices, which are located indoors, such as servers in a server farm providing cloud services, etc., or in large data centers that store data used for Artificial Intelligence (AI) applications. The portable network testing device 100 may also be used to test network nodes located outdoors, such as a local breakout or internet breakouts for apartments, etc. For indoor network devices, there may be limited or no internet connectivity or Global Positioning System (GPS) data available, whereas the portable network testing device 100 may be able to connect to the internet and/or the GPS network for outdoor network devices. Therefore, where there is no network connectivity, the network device locator 122 is configured to display an indoor map of the location, e.g., a data center, which shows the positions of the various components, e.g., server racks in the data center. In an example, the network device locator 122 may be programmatically configured to generate a direction overlay on the indoor map showing directions to the network device 150 from a reference point, e.g., the entrance of the location. If the network device 150 is outdoors, the network device locator 122 may generate a map and track the technician's position to show accurate directions to the network device 150 while updating the map display dynamically based on the technician's movements, using, for example, GPS connectivity.

When the technician reaches the network device 150 to be tested based on the map, the network device locator 122 can instruct the technician to obtain an identifying indicium, such as a bar code or a Quick Response (QR) code of the network device 150 using an imaging device such as the camera 106. In an example, the bar code or the QR code can be affixed to the rack for verification. In an example, the technician handling the portable network testing device 100 is instructed to place the portable network testing device 100 in front of the network device 150, e.g., a server rack, so that the network nodes 160 are in the field of view of the camera 106. Upon verifying that the network device 150 is correctly identified, the network tester 114 provides information regarding one or more of the network nodes 160 to be tested via a label list 1142 and a corresponding test list 1162 to the component identifier 124. The label list 1142 includes a listing of the various network nodes/ports following a specific schema, which identifies not only the data center or location of the network device 150 but also the network device 150, the panel within the network device 150, etc. The network device locator 122 can also be configured to indicate via the MR overlay display 118 if the network device is identified incorrectly based on the scanned identifying indicium not being included in the test list 1162.

The component identifier 124, based on the label list 1142, generates an MR overlay display 118 indicating a subset of one or more of the network nodes 160 to be tested via selectable controls. When the portable network testing device 100 receives selection of one of the virtual buttons corresponding to a network node to be tested, the selection information is passed to the test list provider 126, which displays a corresponding test list 1162 of tests to be conducted on the selected network node. As each test is completed, the test list 1162 can be updated to indicate the completion of the test until the suite of tests in the test list 1162 for the selected network node has been executed. Upon completion of tests for the first selected network node, the component identifier 124 waits for the next selection of the subset of network nodes to be tested and the process of producing the corresponding test list, enabling the technician to complete the tests is repeated until the tests in the test list 1162 for the subset of network nodes to be tested are executed. The results validator 116 records the results 1164 of the tests conducted on the network nodes. In an example, the results 1164 can be recorded on the processor-readable medium 104 and further uploaded to the test server 170 for further analysis.

FIG. 1B shows a block diagram of the workflow provider 120 according to an example of the present disclosure. The workflow provider 120 receives a preliminary workflow 1238 generated by the workflow model 130. In an example, the workflow model 130 can be an Artificial Intelligence (AI) model trained on data regarding the workflows that were generated and executed. Based on the label list 1142 of the network devices/nodes to be tested, the workflow model 130 may generate a preliminary workflow 1238 specifying steps to be executed for conducting the tests and the time required for the execution of the steps. Generative Artificial Intelligence (Gen. AI) models like ChatGPT™ or Google Gemini™ can generate content, including workflow designs and instructions, based on specific prompts. The workflow model 130 can learn to identify patterns and optimize workflows and may further improve from feedback data. Tools such as but not limited to Whimsical AI™ or Miro™ can turn the workflows into visuals, e.g., automatically generating flowcharts and visualizing processes. The workflow model 130 thus generates the preliminary workflow 1238 based on the label list 1142 and a reference location, e.g., the location from which the technician may begin commute to the work site of the network device 150. In an example, the label list 1142 may include a plurality of network devices scattered over multiple work sites. In an example, the worksite closest to a reference location, e.g., a technician's office location, may be selected to begin generation of the workflow. The steps in the preliminary workflow 1238 depend on the network devices and nodes to be tested. The steps may be associated with an estimated time of completion.

The default arrangement of steps in a workflow may be based on the order of listing of the network nodes in the label list 1142, e.g., alpha-numeric order of the network node identifiers, or may be based on “collocated” order. Following the default order adds a substantial amount of technician movement and relocation from one location to another, raising issues such as recalibration of test devices, tangling up of test cords, etc. The workflow model 130 can be trained to generate the preliminary workflow 1238 based on the locations of the network devices and the network nodes, e.g., rack location of each connection to be tested. The workflow can be further optimized within the rack/cabinet to minimize movement and potential mistakes, as well as minimize re-referencing steps to minimize testing time and increase efficiency. The difference brought about by the optimization of the preliminary workflow 1238 based on the location of the network devices is more pronounced in outdoor environments, e.g., apartment buildings where secured areas may need to be accessed to reach the network devices to be tested. The accuracy of the workflow model 130 can further increase with usage via feedback provided by technicians upon completing the jobs/work orders based on the automatically generated workflows.

The workflow provider 120 includes an input receiver 1232, a workflow optimizer 1234, and a workflow generator 1236. The input receiver 1232 receives from the workflow model 130. The preliminary workflow 1238 generated from the workflow model 130 is received at the input receiver 1232. The workflow optimizer 1234 can access the preliminary workflow 1238 and receive inputs specific to the technician and/or the portable network testing device 100. For example, workflow optimizer 1234 may allow the technician to provide certain inputs, such as but not limited to, the starting location for commuting to the worksite and changes in location data automatically received from inputs such as sensor data emitted by the GPS sensors of the portable network testing device 100 or weather data from the internet. The estimated time for completion of the testing may be adjusted based on the aforementioned factors. Thus, an optimized workflow 1222 is generated by the workflow generator 1236.

Similarly, the estimated time can be adjusted based on inputs from other components of the MR-based network test application 110. For example, the component identifier 124 may identify faulty components during the MR overlay display generation process. The workflow generator 1236, based on the estimates from the workflow model 130, may adjust the estimated time of completion based on the technician fixing the faults. Furthermore, as each step is completed, the workflow 1222 may be updated to indicate the remaining steps and the remaining time by the workflow generator 1236. In an example, the workflow generator 1236 may also grade a particular job based on the estimated time versus the completion time.

FIG. 1C shows a block diagram of the component identifier 124 according to an example of the present disclosure. In an example, the component identifier 124 includes one or more object recognition models 1242, an object locator 1244, and a selectable control generator 1246. The object recognition models 1242 include machine learning (ML) models trained to detect objects such as the various network nodes or network elements that are to be tested. The trained object recognition models 1242 can output various probabilities or likelihoods corresponding to the various types of network nodes, such as network nodes selected for testing, network nodes not selected for testing, malfunctioning network nodes, etc.

A few object recognition models and techniques are discussed herein by way of illustration, other object recognition models and techniques can also be employed in accordance with aspects of the disclosure. Object detection requires both classifying objects and pinpointing their exact locations or positions within the field of view 108, adding complexity to the detection process. Accordingly, when an object is identified by the object recognition models 1242, the object locator 1244 receives the region within the field of view 108 where the object is identified and may mark the region via techniques such as anchor boxes. However, certain object recognition techniques, such as Region-based Convolutional Neural Network (RCNN), can generate region proposals and then classify and refine object locations, unifying the object location and recognition tasks. Other object recognition examples can include single-shot detectors such as You Only Look Once (YOLO) that classify and localize objects in a single pass, reducing the test time. Depending on the variety of network components to be identified and tested, techniques such as anchor boxes, multiple feature maps, etc., can be employed. Therefore, while object recognition models 1242 and the object locator 1244 are shown as separate components, it can be appreciated that this is for illustration purposes and that the functions of the object locator 1244 can also be achieved in one step by some of the object recognition models 1242.

The object recognition models 1242 can be trained via supervised or unsupervised learning techniques for recognition of the various network components on a panel, which are to be tested. The training data can include in addition to the images of the panels with the various network nodes or ports, the schema used in the label lists as described above to identify the specific network nodes/ports within a panel of the network device 150 that are to be tested and those network nodes which are not selected for testing. Upon identification of the subset of network nodes to be tested, along with the accurate position of the subset of network nodes within the field of view 108, the selectable control generator 1246 can be configured to programmatically generate within the anchor boxes corresponding to the subset of network nodes. The selectable control generator 1246 can be further configured to programmatically render selectable controls such as virtual buttons associated with the anchor boxes on a display of the portable network testing device 100, particularly in the field of view 108, which buttons a technician can activate to execute the corresponding tests. One method for the generation of selectable controls is described herein by way of illustration, other methods can also be used for generating the selectable controls for the subset of network nodes in accordance with other aspects of the disclosure. In an example, the selectable control generator 1246 can be configured to generate grayed out boxes for the network nodes within the field of view 108 that are not included in the label list or which are not selected for testing.

In yet other examples, the object recognition models 1242 can also be trained to identify a malfunctioning network node from the field of view 108. The malfunctioning network node may or may not be selected for testing, i.e., included in the label list 1142. The selectable control generator 1246 can display another selectable control, e.g., a ‘help button’ for the malfunctioning network node on the MR overlay display 118. The MR-based network test application 110 can be configured to display instructions for fixing the malfunctioning network node upon receiving a selection of the help button.

Described below are a few methods executed by the portable network testing device 100. It may be noted that the methods are provided by way of example, as there may be a variety of ways to carry out the method described herein. Each block shown in the figures may further represent one or more processes, methods, or subroutines, and one or more of the blocks may include processor-readable instructions stored on the non-transitory processor-readable medium 104 and executed by a processor (e.g., processor 102) or other type of processing circuit to perform one or more operations described herein. In some examples, the methods described herein may be executed or otherwise performed by other systems, or a combination of systems.

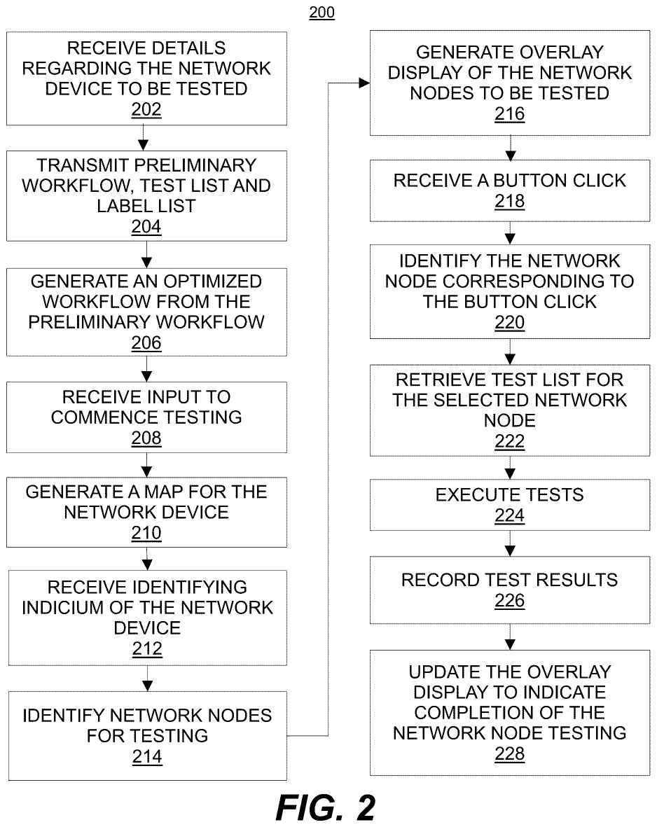

FIG. 2 shows a flowchart of a network device testing method 200 in accordance with an example. The method begins at 202 with the portable network testing device 100 receiving details regarding the network device 150 to be tested. The instructions to test the network device 150 can be configured on the test server 170 by a supervisor. Based on the input from the supervisor, the preliminary workflow 1238 is generated and transmitted to the portable network testing device 100, along with the test list 1162 and the label list 1142 are transmitted to the portable network testing device 100 at 204. At 206, the workflow 1222 is generated by optimizing the preliminary workflow 1238 using real-time inputs gathered by the portable network testing device 100. At 208, the portable network testing device 100 receives an input to commence the tests, and the network device locator 122 of the portable network testing device 100 generates a map to the network device 150 at -210 based on network connectivity. At 212, the portable network testing device 100 receives the identifying indicium of the network device 150. At 214, based on the received identifying indicium, the component identifier 124 identifies via the label list 1142, a subset of the network nodes 160 to be tested using the object recognition models 1242 at 216. Accordingly, at 216, the MR overlay display 118 is generated with the subset of network nodes 160 identified thereon as selectable controls, e.g., buttons.

When the component identifier 124 receives a click from one of the buttons at 218. At 220, the component identifier 124 identifies the network node corresponding to the button click received at 218. At 222, the component identifier 124 retrieves the test list 1162, including tests to be conducted for the selected network node. The portable network testing device 100 executes the tests on the selected network node at 224 per the inputs from the technician, and the results are recorded at 226 by storing the results to a local storage of the portable network testing device 100 and/or uploading the results of the tests to the test server 170. The MR overlay display 118 is updated at 228 to indicate the tested node. In an example, the portable network testing device 100 may determine that there are more network nodes to be tested, and the process detailed above is repeated for each of the network nodes to be tested.

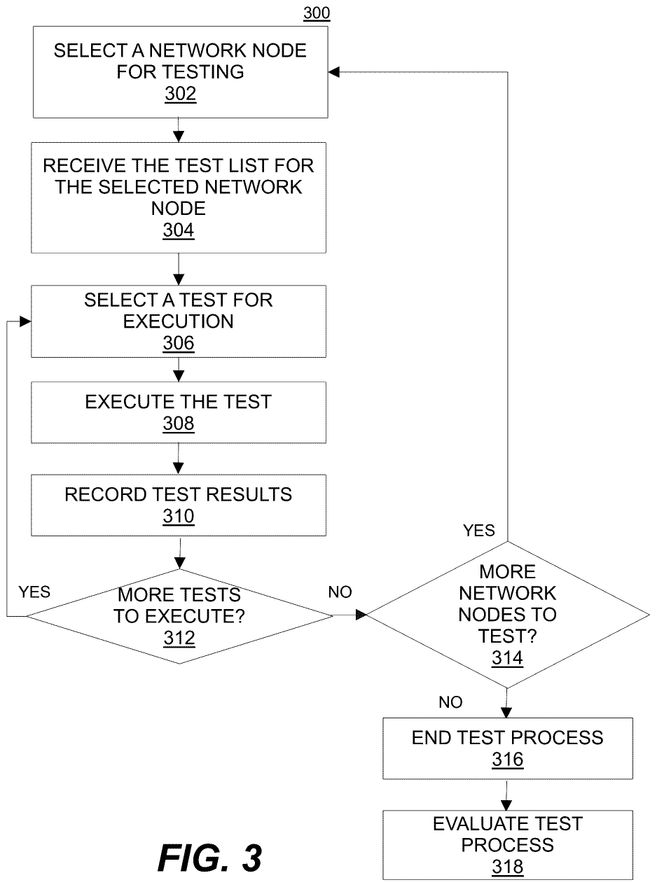

FIG. 3 shows a flowchart of a test execution method 300 for a selected network node in accordance with examples disclosed herein. At 302, the portable network testing device 100 selects a network node from a subset of the network nodes that are to be tested. At 304, the portable network testing device 100 receives the test list 1162 for the network node selected for testing by the technician via the button click. In an example, the tests administered to the network node can include, without limitation, tests for insertion loss, optical return loss, and fiber length, a fiber inspection test on cables of a fiber or cables for a bulkhead, etc. As mentioned above, the tests are executed according to the steps specified in the optimized workflow 1222. At 306, a test is selected from the test suite for execution, and the selected test is executed at 308. The results validator 116 records the test results at 310 upon completion of the test execution. It is determined at 312 if further tests remain in the test suite to be executed on the selected network node. If yes, the method 300 returns to 304 to select the next test on the test list 1162 for the selected network node. If at 310 it is determined that no further tests remain on the test list for execution, the method 300 determines at 312 if further network nodes remain to be tested. If yes, the method 300 returns to 302 to select the next network node for testing, else the method 300 ends the test process at 316. An evaluation of the test process for efficiency is provided at 318 based on a comparison of the optimized workflow 1222 and the actual execution of the test process.

It can be appreciated that the selection of network nodes and the test execution is described above as a serial procedure only for illustration purposes, and that multiple network nodes can be selected at a time and tests can be executed on them in parallel.

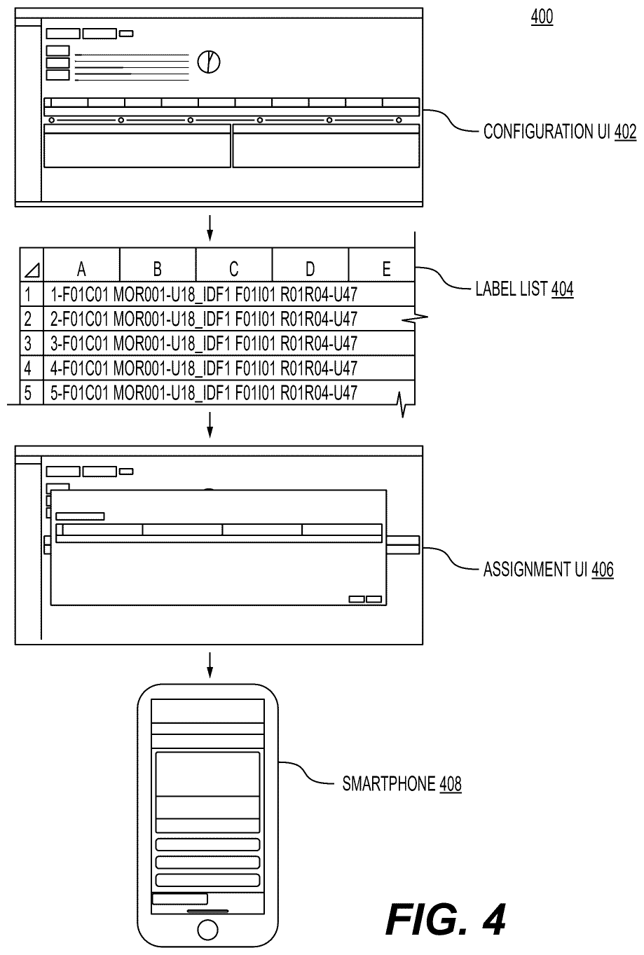

FIG. 4 shows the various tools, including UIs, employed in the process of creating tests for network devices in accordance with examples disclosed herein. Initially, a job or work order is created on the test server 170 for the technician using a configuration UI 402. In an example, a job template may be used with test-specific configuration detailing the tests that are to be executed. As part of the configuration process, a format 404 of the label list 1142 can be added to the job using, for example, a generator or by importing text files such as a Comma Separated Value (CSV) file. The information in the format 404 may include, without limitation, location(s) of the network device(s) to be tested, which includes the building, floor, room, rack, panel, and port. Different schemas may be implemented to specify the location details. The implemented schemas are descriptive so that a reader can determine the location. The job is assigned to a technician via an assignment UI 406. The technician may employ a smartphone 408, which is capable of executing the MR-based network test application 110 as the portable network testing device 100. Alternately, a proprietary device with appropriate hardware, including the processor 102, the non-transitory processor-readable medium 104, the camera 106, and other peripheral devices capable of executing the MR-based network test application 110, may also be employed as the portable network testing device 100.

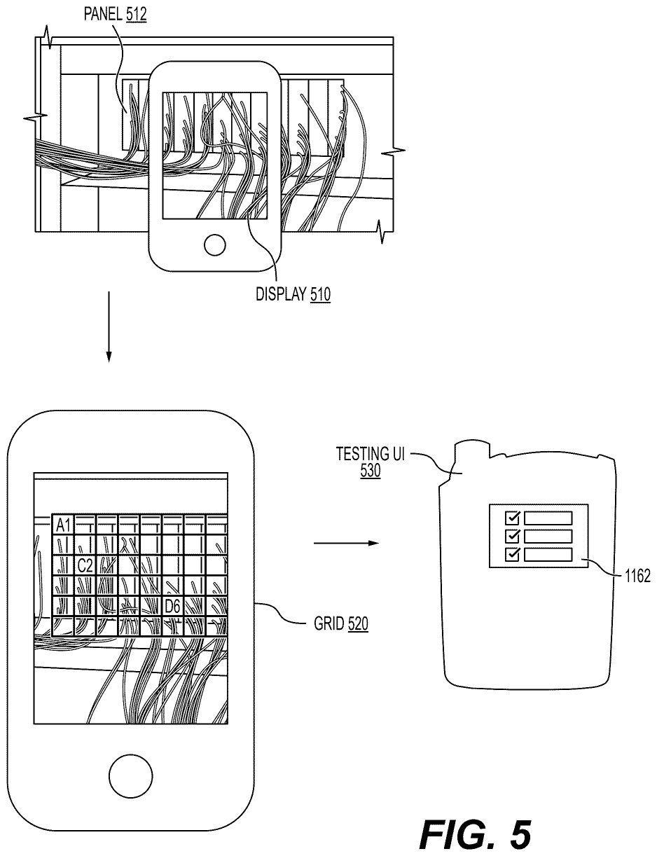

FIG. 5 shows the various AR user interfaces generated by the MR-based network test application 110 in accordance with the disclosed examples. As mentioned herein, on opening a job or work order in the MR-based network test application 110 in the smartphone 408 which in this instance is employed as the portable network testing device 100, the technician is initially instructed to focus the camera 106 so that the panel 512 bearing network nodes to be tested is within the field of view 108 as shown in the display 510. When the panel 512 with the network nodes to be tested is properly focused within the field of view 108, the MR overlay display 118 is generated. In one example, the MR overlay display 118 is configured as a grid 520 that covers a portion of the network device 150 with the various network nodes 160. The network nodes 160 are identified therein with selectable buttons forming cells of the grid 520 labeled, for example, as A1, C2, D6, etc. In another example, network nodes within the field of view 108 other than the subset of network nodes to be tested can have corresponding grayed out controls or gray buttons displayed within the grid, indicating that they are not selectable, as such network nodes do not need to be tested. In another example, certain selectable buttons can be configured to indicate any malfunctioning network nodes when the camera 106 is initially focused on the panel 512. When the technician selects one of the selectable buttons corresponding to a network node, a testing UI 530 including the test list 1162 is displayed on the smartphone 408. When all the tests in the test list 1162 are completed, the test results may be recorded locally on the processor-executable non-transitory medium 104 and/or uploaded to the test server 170.

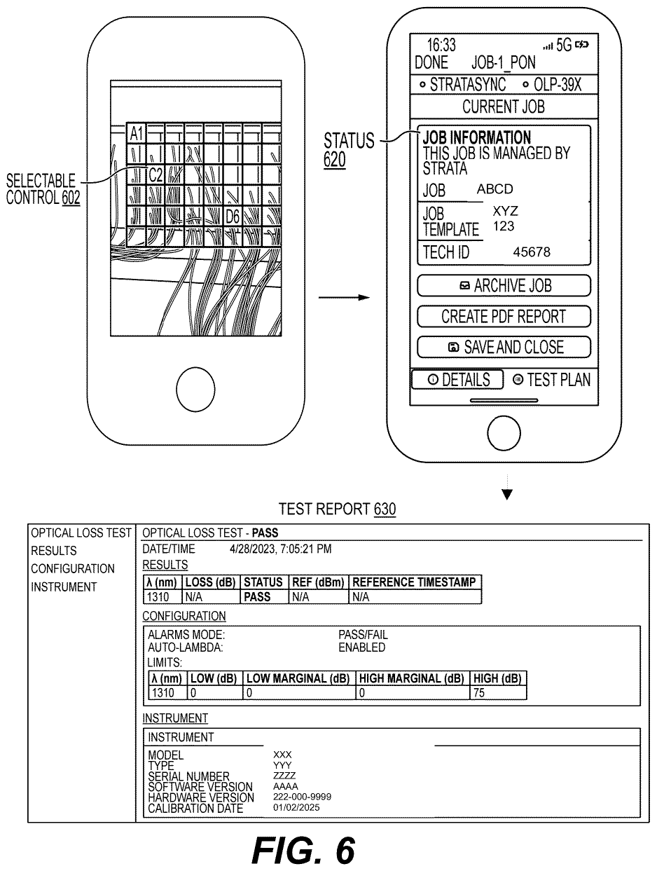

FIG. 6 shows the MR-based UIs that are generated during testing of the network nodes in accordance with the disclosed examples. On completing the tests from the test list 1162 on C2, the selectable control 602 is updated on the grid 520, indicating that the network node C2 is tested. In an example, the update to the selectable control 602 can indicate if the network node C2 has passed or failed the test. By way of illustration, colors may be used to indicate the success or failure of the tests conducted on the network nodes. For example, the selectable control 602 may be updated in green if C2 passed all the tests in the test list 1162, and the selectable control 602 may be updated to red if the network node C2 has failed in one or more of the tests in the test list 1162. If the portable network testing device 100 is connected to the internet and the test results 1164 are uploaded to the test server 170, then the test server 170 may analyze the test results and transmit a solution to fix the malfunctions that caused the network node C2 to fail the tests. Upon applying the fix, the network node C2 can be tested again, and if successful, the overlay display is updated to indicate successful testing of the network node C2. The process of testing outlined above is repeated for each of the network nodes, A1, C2, and D6. The status 620 of the tests may be displayed on the smartphone 408. The measurements made in the test can be uploaded to the test server 170 for further analysis and generation of the test report 630.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims-and their equivalents-in which all terms are meant in their broadest reasonable sense unless otherwise indicated.

What is claimed is:

1. A portable network testing device, comprising:
at least one processor;
a non-transitory, processor-readable medium storing processor-readable instructions that cause the at least one processor to:
receive a work order that specifies one or more network nodes of a network device to be tested;
generate a mixed reality (MR) overlay display on a panel of the network device bearing the one or more network nodes,
wherein the MR overlay display is generated based on a label list of identification data of components of the network device, including the one or more network nodes, and the MR overlay display indicates the one or more network nodes to be tested via selectable controls;
display a corresponding test list of tests to be conducted on a selected network node of the one or more network nodes;
store results of the tests conducted on the selected network node; and
repeat the steps of generating the MR overlay display, displaying the corresponding test list, and recording the test results until completion of the tests on the test list.

2. The portable network testing device of claim 1, wherein the non-transitory processor-readable medium comprises further instructions that cause the at least one processor is to:
receive a preliminary workflow specifying steps to be executed for conducting the tests and time required for the execution of the steps,
wherein the preliminary workflow is optimized based at least on one or more of minimizing movement between the one or more network nodes during testing and minimizing re-referencing steps.

3. The portable network testing device of claim 2, wherein the non-transitory processor-readable medium comprises further instructions that cause the at least one processor is to:
generate an optimized workflow by further optimizing the preliminary workflow via real-time inputs from Global Positioning System (GPS) sensors.

4. The portable network testing device of claim 3, wherein the non-transitory processor-readable medium comprises further instructions that cause the at least one processor is to:
provide an evaluation of testing process on completion of the tests based on a comparison of time estimated from the optimized workflow versus actual time taken to complete the tests.

5. The portable network testing device of claim 1, wherein the non-transitory processor-readable medium comprises instructions that further cause the at least one processor is to:
generate a map of a route to the network device, including the one or more network nodes.

6. The portable network testing device of claim 5, wherein to generate the map, the non-transitory processor-readable medium comprises instructions that further cause the at least one processor is to:
determine if the portable network testing device can access Global Positioning System (GPS) network; and
generate the map from a reference location if the portable network testing device cannot access the GPS network and,
generate the map from a location of the portable network testing device if the portable network testing device can access the GPS network.

7. The portable network testing device of claim 1, wherein to generate the MR overlay display, the non-transitory processor-readable medium comprises instructions that further cause the at least one processor is to:
receive an identifying indicium of the network device, including the one or more network nodes to be tested.

8. The portable network testing device of claim 7, wherein to generate the overlay, the non-transitory processor-readable medium comprises instructions that further cause the at least one processor is to:
retrieve the label list associated with the test list if an identifying indicium of the network device corresponds to the test list; and
indicate via the MR overlay display that the network device is identified incorrectly if the identifying indicium is not associated with the test list.

9. The portable network testing device of claim 8, wherein to generate the overlay, the non-transitory processor-readable medium comprises instructions that further cause the at least one processor is to:
identify the one or more network nodes from the label list in a field of view of a camera of the portable network testing device using trained object recognition models.

10. The portable network testing device of claim 9, wherein the object recognition models are trained to identify components of the network device, including the one or more network nodes.

11. The portable network testing device of claim 9, wherein to display the one or more network nodes via selectable controls, the non-transitory processor-readable medium comprises instructions that further cause the at least one processor is to:
display a grid within the field of view,
wherein the grid covers a portion of the network device, including the one or more network nodes; and
display the selectable controls over the one or more network nodes within the grid.

12. The portable network testing device of claim 9, wherein the non-transitory processor-readable medium comprises instructions that further cause the at least one processor is to:
display grayed out controls corresponding to a subset of the network nodes within the field of view, other than the one or more network nodes to be tested.

13. The portable network testing device of claim 1, wherein the non-transitory processor-readable medium comprises further instructions that cause the at least one processor is to:
identify, via trained object recognition models, at least one malfunctioning network node of the network device from a field of view of a camera included in the portable network testing device;
display a help button for the malfunctioning network node on the MR overlay display;
display instructions for fixing the malfunctioning network node upon receiving a selection of the help button; and
indicate via the MR overlay display if the malfunctioning network node is fixed.

14. The portable network testing device of claim 1, wherein the non-transitory processor-readable medium comprises further instructions that cause the at least one processor is to:
store results of the tests conducted on the one or more network nodes on a local storage of the portable network testing device; and
upload results of the tests conducted on the one or more network nodes to a test server.

15. A method of testing a network device comprising:
receiving, by a processor, a work order that specifies one or more network nodes of a network device to be tested;
generating, by the processor, a Mixed Reality (MR) overlay display on a panel of the network device bearing the one or more network nodes,
wherein the MR overlay display is generated based on a label list of identification data of components of the network device, including the one or more network nodes, and the MR overlay display indicates the one or more network nodes to be tested via selectable controls;
displaying, by the processor, a corresponding test list of tests to be conducted on a selected network node of the one or more network nodes; and
repeating, by the processor, the steps of generating the MR overlay display, displaying the corresponding test list, and updating the MR overlay display until completion of the tests on the test list.

16. The method of testing the network device of claim 15, further comprising:
updating, by the processor, the MR overlay display upon completion of testing of one of the one or more network nodes.

17. The method of testing the network device of claim 16, further comprising:
indicating, by the processor, success or failure of the tests on the MR overlay display upon the completion of the tests on the test list.

18. A non-transitory processor-readable storage medium comprising processor-readable instructions that cause a processor to:
receive a work order that specifies one or more network nodes of a network device to be tested;
generate a Mixed Reality (MR) overlay display on a panel of the network device bearing the one or more network nodes,
wherein the MR overlay display is generated based on a label list of identification data of components of the network device, including the one or more network nodes, and the MR overlay display indicates the one or more network nodes to be tested via selectable controls;
display a corresponding test list of tests to be conducted on a selected network node of the one or more network nodes; and
repeat the steps of generating the MR overlay display and displaying the corresponding test list until completion of the tests on the test list.

19. The non-transitory processor-readable storage medium of claim 18, comprising trained object recognition models that are trained in identifying the components of the network device from the label list, including the one or more network nodes.

20. The non-transitory processor-readable storage medium of claim 18, comprising further processor-readable instructions that cause the processor to:
execute tests that include optical return loss test, fiber length test, and fiber inspection tests, optical power test, optical loss test, optical return loss test, fiber length test, polarity, inspection test, Passive Optical Networking (PON-ID) and throughput tests.
